(19) United States
(12) Patent Application Publication
(10) Pub. No.: US 2009/0233462 A1
(43) Pub. Date: Sep. 17, 2009

(54) Cable connector assembly with FFC module

(75) Inventor: Yung-Chang Cheng, Tu-Cheng (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 12/381,480

(22) Filed: Mar. 11, 2009

(30) Foreign Application Priority Data
Mar. 11, 2008 (CN) 200810019923.6

(51) Int. Cl. H01R 12/00; H01R 12/24

(52) U.S. Cl. 439/65; 439/495

(57) ABSTRACT

A cable connector assembly comprises a FFC module and a receptacle connector mating with the FFC module. The receptacle connector comprises an insulative housing and a plurality of terminals received into the insulative housing. The FFC module comprises a pair of FFCs paralleled with each other and at least one reinforcing plate disposed between the pair of FFCs and integrated with the pair of FFCs. Each FFC defines a plurality of conductors arranged side by side, and insulating films laminated on the both sides of the conductors. Two end portions of the conductors are exposed out of the insulating film for contacting with the terminals to achieve electric connection.

### FIELD OF THE INVENTION

The present invention relates to a cable connector assembly, and more particularly to a cable connector assembly with a FFC module having a simple structure and in a low-cost.

### DESCRIPTION OF PRIOR ART

U.S. Pat. No. 7,128,596 B2 issued to Masaki (hereinafter referred to as Masaki '596 Pat.) on Oct. 31, 2006 discloses a plug-type connector 2, a pair of FFCs 1, 100 attached to the plug-type connector 2 and a base connector 3 mating with the plug-type connector 2. Please referring to FIGS. 1, 2 and 8 in the above mentioned patent. The plug-type connector 2 further includes a holder 22 for holding the end portions 1a of a pair of FFCs 1, 100 and a fixing member 23 for fixing the pair of FFCs 1, 100 to the holder 22. However, the plug-type connector 2 has a relatively complex structure so that the productive cost thereof is more high and the manufacturing process thereof is more difficulty.

As discussed above, an improved cable connector assembly overcoming the shortages of existing technology is needed.

### SUMMARY OF THE INVENTION

Accordingly, an object of the present invention is to provide a cable connector assembly with a FFC module having a simple structure and in a low-cost.

In order to achieve the above-mentioned objects, a cable connector assembly comprises a FFC module and a receptacle connector mating with the FFC module. The receptacle connector comprises an insulative housing and a plurality of terminals received into the insulative housing. The FFC module comprises a pair of FFCs paralleled with each other and at least one reinforcing plate disposed between the pair of FFCs and integrated with the pair of FFCs. Each FFC defines a plurality of conductors arranged side by side, and insulating films laminated on the both sides of the conductors. Two end portions of the conductors are exposed out of the insulating film for contacting with the terminals to achieve electric connection.

In order to achieve the above-mentioned objects, a FFC module comprises a pair of FFCs paralleled with each other, each FFC defines a plurality of conductors arranged side by side, and insulating films laminated on the both sides of the conductors. Two end portions of the conductors are exposed out of the insulating film. A reinforcing plate is disposed between the pair of FFCs and integrated with the pair of FFCs for supporting one end of the pair of FFCs.

Other objects, features and advantages of the invention will be apparent from the following detailed description taken in connection with the accompanying drawings.

### BRIEF DESCRIPTION OF THE DRAWINGS

FIG. 1 is a perspective view of a cable connector assembly in accordance with the present invention;

FIG. 2 is an exploded, perspective view of the cable connector assembly;

FIG. 3 is an exploded, perspective view of the cable connector assembly in another point of view different from FIG. 2.

### DETAILED DESCRIPTION OF PREFERRED EMBODIMENTS

Reference will now be made to the drawing figures to describe the present invention in detail.

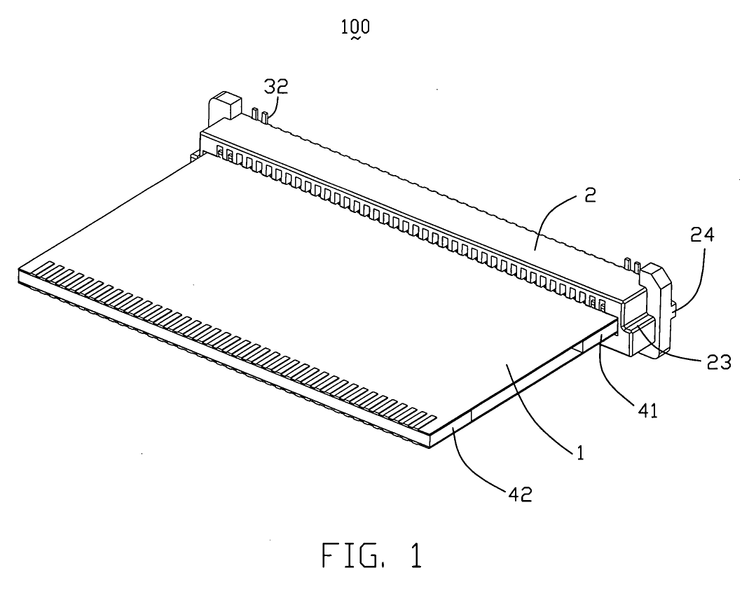

Referring to FIGS. 1 to 3, a cable connector assembly 100 in accordance with the present invention includes a FFC module and a receptacle connector mating with the FFC module.

Referring to FIGS. 1 to 3, the receptacle connector is a board to board connector in this embodiment, comprising an insulative housing 2 and a plurality of terminals 3 disposed in the insulative housing 2.

The insulative housing 2 defines a top wall, a bottom wall opposite to the top wall and a pair of side walls connected with the top wall and the bottom wall. The insulative housing 2 defines a front face and a rear face opposite to the front face. A receiving slot 22 is recessed rearwardly from the front face of the insualtive housing 2 and surrounded by the top wall, the bottom wall and the pair of side walls. A plurality of terminal receiving passages 21 are respectively formed on the inner surface of the top wall and bottom wall for receiving the terminals 3 and communicated with the receiving slot 22. A pair of protrusions 23 extends outwardly from two lateral sides of the pair of side walls. A pair of supporting portions 24 extends outwardly from the lateral sides of the pair of side walls, and each supporting portion 24 has a projection 240, 241.

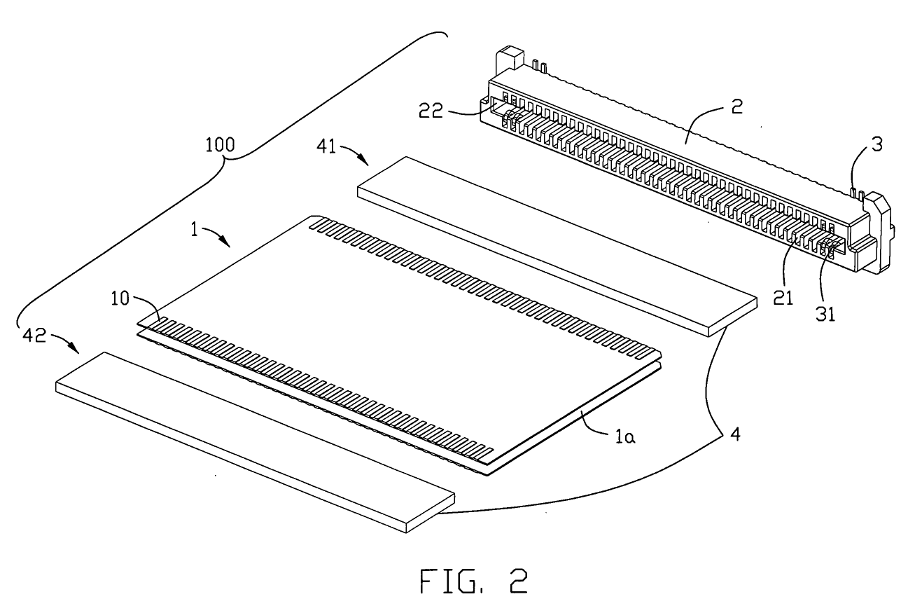

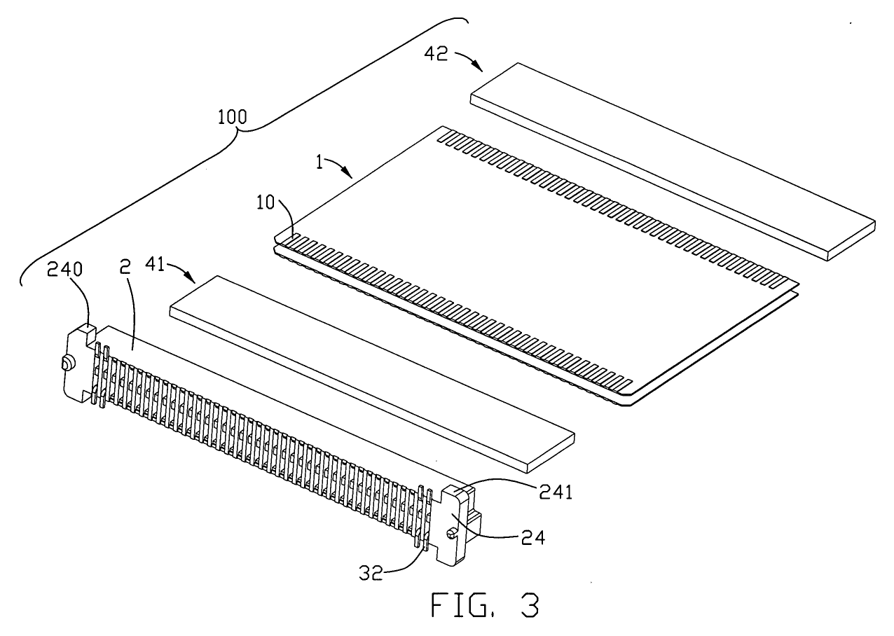

Referring to FIGS. 2 to 3, the terminals 3 are inserted into the terminal receiving passages 21 of the insualtive housing 2 in a rear to front direction. Each terminal 3 has a contacting portion 31 and a soldering portion 32 perpendicular to the contacting portion 31. Each contacting portion 31 of the terminal 3 is received into the terminal receiving passage 21. Each soldering portion 32 of the terminal 3 extends out of the terminal receiving passage 21 and attaches to the rear face of the insualtive housing 2.

Referring to FIGS. 1 to 3, the FFC module includes a pair of FFCs 1 and a reinforcing plate 4 disposed between the pair of FFCs 1. The FFC module defines a front mating portion, a rear mating portion and a flexible portion connected with the front mating portion and the rear mating portion.

The pair of FFCs 1 of the FFC module are disposed in a paralleled relationship with their inner sides la being opposite to each other. Each FFC 1 defines a plurality of conductors 10 arranged side by side, and insulating films laminated on the both sides of the conductors 10. Two end portions of the conductors 10 are exposed out of insulating films of the pair of FFCs 1 for contacting with and pressed by the contacting portions 31 of the terminals 3, thereby to achieve electric connection.

The reinforcing plate 4 is formed of plastic material and included by a front reinforcing plate 41 and a rear reinforcing plate 42. The front and rear reinforcing plates 41, 42 are disposed between the pair of FFCs 1 for supporting the front and rear ends of the pair of FFCs 1. The front reinforcing plate 41 has a front face aligning with the front edge of the pair of FFCs 1 and the rear reinforcing plate 42 has a rear face aligning with the rear edge of the pair of FFCs 1. In another embodiment, the front and rear reinforcing plate each defines a pair of lengthwise ribs respectively formed at the front end thereof. The ribs protrude upwardly and downwardly from a top and bottom surface of the reinforcing plate 41, 42 for protecting the end portions of the conductors 10. The front and rear reinforcing plates 41, 42 have a width the same with the width of the pair of FFCs 1. The front reinforcing plate 41 and rear reinforcing plate 42 are respectively integrated with the pair of FFCs 1 through paste technology.

As the front and rear reinforcing plates 41, 42 existed, the front and rear ends of the pair of FFCs 1 are hardened to meet the front end of FFCs 1 can be easily inserted into the receiving slot 22 of the insualtive housing 2 of the receptacle connector. And, the rear end of FFCs 1 can be connected to a board end connector or a plurality of wires. In addition, as a middle portion of the pair of FFCs 1 is not supported by a reinforcing plate 4, so the middle portion of the pair of FFCs 1 is remain flexible. The front mating portion of the FFC module is formed by a front end portion of the pair of FFCs 1 and a front reinforcing plate 41. The rear mating portion of the FFC module is formed by a rear end portion of the pair of FFCs 1 and a rear reinforcing plate 42. The flexible portion of the FFC module is connected with the front mating portion and rear mating portion.

Further more, the reinforcing plate 4 also has a function for preventing the signal interference between the pair of FFCs 1 and adjusting the characteristic impedance of the pair of FFCs 1. So the FFC module also can be applied in the cable connector assembly which has a simple structure and in a low-cost. The reinforcing plate 4 also can be designed to wholly support the pair of FFCs 1. In other words, the front and rear reinforcing plates 41, 42 can be adjusted in length and width randomly so that the FFC module as described is in the rigid and flexible inter-change.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What I claimed is:

1. A cable connector assembly, comprising:
a FFC module and a receptacle connector mating with the FFC module;
the receptacle connector comprising an insulative housing and a plurality of terminals received into the insulative housing;
the FFC module comprising a pair of FFCs paralleled with each other and at least one reinforcing plate disposed between the pair of FFCs and integrated with a pair of inner faces of the pair of FFCs, each FFC defining a plurality of conductors arranged side by side, and insulating films laminated on the both sides of the conductors, two end portions of the conductors exposed out of the insulating film for contacting with the terminals to achieve electric connection.

2. The cable connector assembly as recited in claim 1, wherein the size of the reinforcing plate can be adjusted to make the FFC module as described in the rigid and flexible inter-change.

3. The cable connector assembly as recited in claim 2, wherein the reinforcing plate is defined by a front reinforcing plate and a rear reinforcing plate spaced apart with the front reinforcing plate, a front and a rear end portion of the pair of FFCs are respectively supported by the front and rear reinforcing plates.

4. The cable connector assembly as recited in claim 2, wherein the reinforcing plate is integrated with the pair of FFCs through paste technology.

5. The cable connector assembly as recited in claim 3, wherein the FFC module defines a front mating portion formed by a front end portion of the pair of FFCs and a front reinforcing plate, a rear mating portion formed by a rear end portion of the pair of FFCs and a rear reinforcing plate and a flexible portion connected with the front mating portion and rear mating portion.

6. The cable connector assembly as recited in claim 5, wherein the insulative housing of the receptacle connector defines a receiving slot for receiving the front mating portion of the FFC module.

7. The cable connector assembly as recited in claim 1, wherein the insulative housing defines a plurality of terminal receiving passages for receiving the terminals.

8. The cable connector assembly as recited in claim 7, wherein each terminal defines a contacting portion disposed in the terminal receiving passage and a soldering portion extending out of the terminal receiving passage and perpendicular to the contacting portion.

9. The cable connector assembly as recited in claim 3, wherein the front reinforcing plate has a front face aligning with a front edge of the pair of FFCs and the rear reinforcing plate has a rear face aligning with a rear edge of the pair of FFCs.

10. The cable connector assembly as recited in claim 3, wherein a pair of lengthwise ribs are respectively formed at the front end of the front and rear reinforcing plate.

11. The cable connector assembly as recited in claim 10, wherein each pair of the ribs are respectively protruding upwardly and downwardly from a top and bottom surface for protecting the front and rear end portions of the conductors.

12. An FFC module comprising:
a pair of FFCs paralleled with each other, each FFC defining a plurality of conductors arranged side by side, and insulating films laminated on the both sides of the conductors, two end portions of the conductors exposed out of the insulating film;
a reinforcing plate disposed between the pair of FFCs and integrated with the pair of FFCs for supporting one end of the pair of FFCs.

13. The FFC module as recited in claim 12, wherein the FFC module defines a mating portion defined by one end of the pair of FFCs and a reinforcing plate disposed therebetween.

14. The FFC module as recited in claim 12, wherein the reinforcing plate is integrated with the pair of FFCs through paste technology.

15. A flexible cable module assembly comprising
a first flexible cable and a second flexible cable being back to back arranged parallel to each other in a stacked manner along a vertical direction,
the first flexible cable defining opposite first and second end regions along a front-to-back direction perpendicular to said vertical direction;
the second flexible cable defining opposite first and second end areas along said front-to-back direction under condition of the first end area neighboring the first end region;
a set of first conductive pads formed on the first end region of the first flexible cable and facing away from the second flexible cable;
a set of second conductive pads formed on the first end area of the second flexible cable and facing away from the first flexible cable;
a reinforcement being sandwiched between the first end region of the first flexible cable and the first end area of the second flexible cable.

16. The flexible cable module assembly as claimed in claim 15, further including another set of first conductive pads formed on the second end region of the first flexible cable and facing away from the second flexible cable; another set of second conductive pads formed on the second end area of the second flexible cable and facing away from the first flexible cable; another reinforcement being sandwiched between the second end region of the first flexible cable and the second end area of the second flexible cable.

17. The flexible cable module assembly as claimed in claim 16, wherein said first and flexible cables cooperate with said two reinforcement plates to constitute a confined space communicating with an exterior only along a transverse direction perpendicular to both said vertical direction and said front-to-back direction.

18. The flexible cable module assembly as claimed in claim 15, further including an electrical connector having first and second rows of contacts opposite to each other to sandwich the associated first end region of the first flexible cable, first end area of the second flexible cable and reinforcement plate therebetween for mechanical and electrical engagement with the first conductive pads and the second conductive pads thereon.

19. The flexible cable module assembly as claimed in claim 18, wherein said connector defines a front mating face with an opening to receive the associated first end region of the first flexible cable, first end area of the second flexible cable and reinforcement plate therebetween, and during mating the first conductive pads and the second conductive pads are hidden behind the front face while the reinforcement plate is exposed outside of the front face.

20. The flexible cable module assembly as claimed in claim 15, wherein said flexible cable is the flexible flat cable with a plurality of conductors laminated with and sandwiched by two insulative layers on two sides with the end sections exposed to an exterior to form said corresponding conductive pads.
